(19) United States
(12) Patent Application Publication
(10) Pub. No.: US 2008/0113731 A1
(43) Pub. Date: May 15, 2008

(54) Gaming apparatus and control method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/902,600

(22) Filed: Sep. 24, 2007

Related U.S. Application Data
(60) Provisional application No. 60/858,928, filed on Nov. 15, 2006.

(51) Int. Cl. A63F 13/00

(52) U.S. Cl. 463/17; 273/142 E

(57) ABSTRACT

A gaming apparatus includes a roulette wheel having a plurality of numbered pockets, a memory that stores a plurality of control data in each of which at least one of a roulette wheel rotation condition and a ball launching condition and a controller. Based on the control data, probability of receiving a ball in a specific area of the plurality of pockets increases. The controller is operable to accept, during a game executed based on one control data among the plurality of control data, a change operation from the one control data to another control data by a player who has satisfied a predetermined condition.

### CROSS-REFERENCE TO RELATED APPLICATION

This application is based upon and claims the benefit of U.S. Provisional Patent Application Ser. No. 60/858,928, filed on Nov. 15, 2006; the entire contents of which are incorporated herein by reference for all purposes.

### BACKGROUND OF THE INVENTION

1. Field of the Invention

The present invention relates to a gaming apparatus, such as a roulette gaming machine, a bingo gaming machine, etc. and a control method thereof.

2. Description of Related Art

Conventionally, in a roulette game, a game is executed generally by a dealer throwing in a ball onto a roulette wheel. Recently, automation has developed and a gaming apparatus has bee proposed, in which the roulette game progresses completely automatically without the need for the dealer to throw in a ball.

Among such gaming apparatuses, there is a gaming apparatus in which a ball is launched by air as disclosed in the pamphlet of International Publication WO2004/094013. With a gaming apparatus in which the roulette game progresses completely automatically, it is thought to be preferable that a ball fall in each pocket and be received therein with a uniform probability. Because of this, among such gaming apparatuses, there is one designed so as to disturb the behavior of a ball by providing bumps and dips on the surface of the ball track so that the ball falls in each pocket with a uniform probability.

An object of the present invention is to provide a gaming apparatus having new entertainment and a control method thereof.

### SUMMARY OF THE INVENTION

A first aspect of the present invention provides a gaming apparatus which comprises the following configuration. That is, the gaming apparatus comprises a roulette wheel having a plurality of pockets numbered respectively; a memory that stores a plurality of control data; and a controller. In each of the control data, at least one of a roulette wheel rotation condition and a ball launching condition is set so that probability of receiving a ball in a specific area of the plurality of pockets increases. The controller is operable to accept, during a game executed based on one control data among the plurality of control data, a change operation from the one control data to another control data by a player who has satisfied a predetermined condition.

According to the first aspect of the present invention, the pocket(s) included the specific area having the increased probability of receiving the ball is determined by the control data. During the game executed based on the one control data, the operation by the player to change from the one control data to the other control data is accepted when the player has satisfied the predetermined condition.

A second aspect of the present invention provides a gaming apparatus which comprises the following configuration. That is, the gaming apparatus comprises a roulette wheel having a plurality of pockets numbered respectively; a memory that stores a plurality of control data; and a controller. In each of the control data, at least one of a roulette wheel rotation condition and a ball launching condition is set so that probability of receiving a ball in a specific area of the plurality of pockets increases. The controller is operable to accept, during a game executed based on one control data among the plurality of control data, a change operation from the one control data to another control data by a player who has bet on the pocket included the specific area based on the one control data after the ball is received in the specific area.

According to the second aspect of the present invention, the pocket(s) included the specific area having the increased probability of receiving the ball is determined by the control data. During the game executed based on the one control data, the operation by the player to change from the one control data to the other control data is accepted when the player has bet on the specific pocket and the ball has been received in the specific pocket.

A third aspect of the present invention provides a gaming apparatus which comprises the following configuration. That is, the gaming apparatus comprises a roulette wheel having a plurality of pockets numbered respectively; a memory that stores a plurality of control data; and a controller. In each of the controller, at least one of a roulette wheel rotation condition and a ball launching condition is set so that probability of receiving a ball in a specific area of the plurality of the pockets increases. The controller is operable to (a) select, during a game executed based on one control data among the plurality of control data, one player among two or more players who have bet on the pocket included the specific area based on the one control data, and (b) accept a change operation from the one control data to another control data by the one player after the ball is received in the specific area.

According to the third aspect of the present invention, the pocket(s) included the specific area having the increased probability of receiving the ball is determined by the control data. During the game executed based on the one control data, the operation by the player to change from the one control data to the other control data is accepted when the player has bet on the specific pocket and the ball has been received in the specific pocket. At this time, if there are the two or more players who have bet on the specific pocket, the one player is selected among the two or more players and the change operation by the one player is accepted.

A fourth aspect of the present invention provides control method of a gaming apparatus which comprises the following configuration. That is, the control method of the gaming apparatus, comprises: accepting, during a game executed based on one control data among the plurality of control data (in each of the control data, at least one of a roulette wheel rotation condition and a ball launching condition is set so that probability of receiving a ball in a specific area of the plurality of pockets increases), a change operation from the one control data to another control data by a player who has satisfied a predetermined condition.

According to the fourth aspect of the present invention, the pocket(s) included the specific area having the increased probability of receiving the ball is determined by the control data. During the game executed based on the one control data, the operation by the player to change from the one control data to the other control data is accepted when the player has satisfied the predetermined condition.

A fifth aspect of the present invention provides control method of a gaming apparatus which comprises the following configuration. That is, the control method of the gaming apparatus, comprises: accepting, during a game executed based on one control data among a plurality of control data (in each of the control data, at least one of a roulette wheel rotation condition and a ball launching condition is set so that probability of receiving a ball in a specific area of the plurality of pockets increases), a change operation from the one control data to another control data by a player who has bet on the pocket included the specific area based on the on control data after the ball is received in the specific area.

According to the fifth aspect of the present invention, the pocket(s) included the specific area having the increased probability of receiving the ball is determined by the control data. During the game executed based on the one control data, the operation by the player to change from the one control data to the other control data is accepted when the player has bet on the specific pocket and the ball has been received in the specific pocket.

A sixth aspect of the present invention provides control method of a gaming apparatus which comprises the following configuration. That is, the control method of the gaming apparatus, comprises: (a) selecting, during a game executed based on one control data among a plurality of control data (in each of the control data, at least one of a roulette wheel rotation condition and a ball launching condition is set so that probability of receiving a ball in a specific area of the plurality of pockets increases), one player among two or more players who have bet on the pocket included the specific area based on the one control data; and (b) accepting a change operation from the one control data to another control data by the one player after a ball is received in the specific area.

According to the sixth aspect of the present invention, the pocket(s) included the specific area having the increased probability of receiving the ball is determined by the control data. During the game executed based on the one control data, the operation by the player to change from the one control data to the other control data is accepted when the player has bet on the specific pocket and the ball has been received in the specific pocket. At this time, if there are the two or more players who have bet on the specific pocket, the one player is selected among the two or more players and the change operation by the one player is accepted.

### BRIEF DESCRIPTION OF THE DRAWINGS

FIG. 1 is a flow chart showing a control method of a gaming apparatus according to an embodiment of the present invention.

FIG. 2 is a plan view of a roulette apparatus according to the present embodiment.

FIG. 3 is a perspective view of the appearance showing the general configuration of a roulette gaming machine according to the present embodiment.

FIG. 4 is a diagram showing an example of control data.

FIG. 5 is a diagram showing an example of an image displayed on a display panel.

FIG. 6 is a block diagram showing the internal configuration of the roulette gaming machine according to the present embodiment.

FIG. 7 is a schematic diagram showing a storage area of a ROM of the roulette gaming machine according to the present embodiment.

FIG. 8 is a schematic diagram showing a storage area of a RAM of the roulette gaming machine according to the present embodiment.

FIG. 9 is a block diagram showing the internal configuration of the roulette apparatus according to the present embodiment.

FIG. 10 is a schematic diagram showing a storage area of a ROM of the roulette apparatus according to the present embodiment.

FIG. 11 is a block diagram showing the internal configuration of a station according to the present embodiment.

FIGS. 12 to 15 are flowcharts showing game processing of the roulette gaming machine according to the present embodiment.

### DETAILED DESCRIPTION OF THE EMBODIMENT

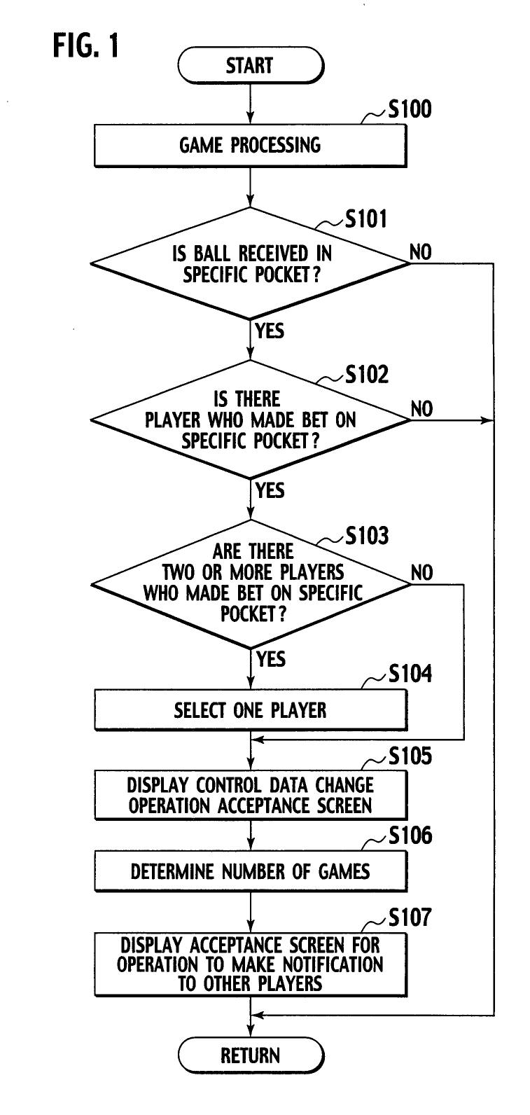

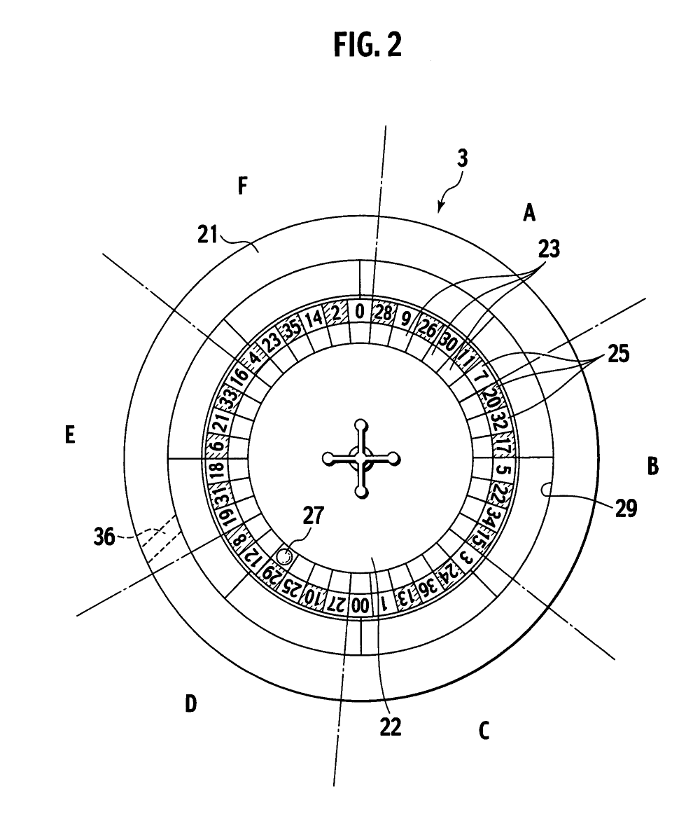

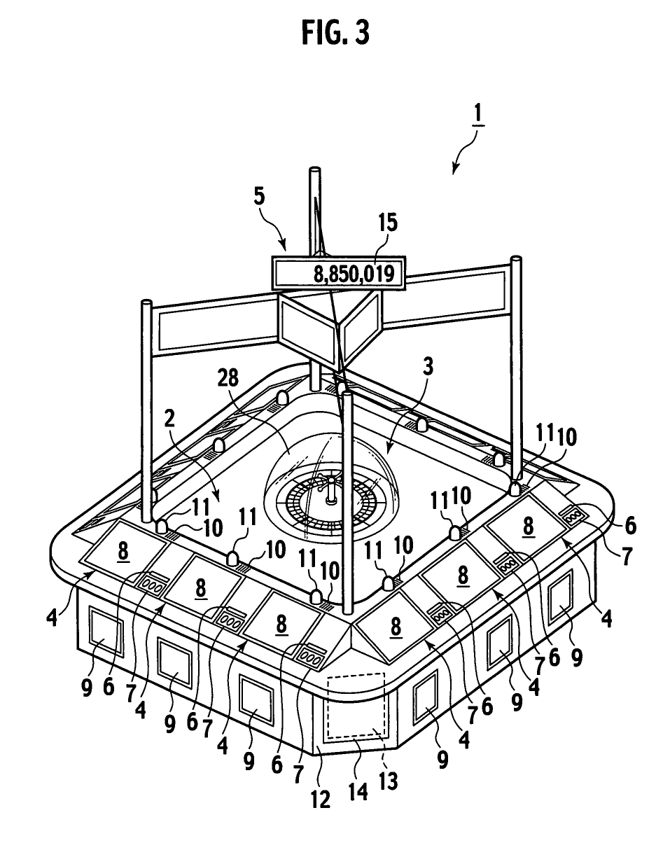

FIG. 1 is a flow chart showing a control method of a gaming apparatus according to an embodiment of the present invention. FIG. 2 is a plan view of a roulette apparatus according to the present embodiment. FIG. 3 is a perspective view of the appearance showing the general configuration of a roulette gaming machine according to the present embodiment.

In the present embodiment, a control method of a roulette gaming machine, as an example of the gaming apparatus, will be described. Although the roulette gaming machine is a gaming apparatus of standalone type not connected to a network, the present invention can also be applied to a gaming apparatus connected to a network.

In a roulette gaming machine 1 according to the present embodiment, a game progresses by one control data. In the control data, at least one of a rotation condition of a roulette wheel 22 and a launching condition of a ball 27 is set, so that probability of receiving the ball in a specific area of a plurality of pockets 23 would increase. The roulette gaming machine 1 according to the present embodiment stores a plurality of control data. In the respective control data, at least one of the rotation condition of the roulette wheel 22 and the launching condition of the ball 27 is set so that a different area of the plurality of the pockets 23 would receive the ball 27 with higher probability.

In the present embodiment, game processing is executed first (step S100). In the game processing, when a player makes a bet in each station 4, rotation of the roulette wheel 22 and launching of the ball 27 is executed and payout is made in accordance with the bet after the ball 27 is received in the pocket 23.

After that, it is determined whether or not the ball 27 has been received in the specific pocket 23 in the game processing in step S100 (step S101). For example, it is determined whether or not the ball 27 has been received in “00” or “0” among the plurality of pockets 23. When it is determined that the ball 27 has not been received in the specific pocket 23 (step S101: NO), the processing moves to step S100.

On the other hand, when it is determined that the ball 27 has been received in the specific pocket 23 (step S101: YES), it is determined whether or not there is a player who made the bet on the specific pocket 23 (step S102). “To make the bet on the specific pocket 23” means, for example, to determine whether or not there is a player who made the bet on “00” by the “straight bet” (the detail of the “straight bet” will be described later). Alternatively, it may also mean to determined whether or not there is a player who made the bet on “00” by other betting methods (the detail of other betting methods will be described later) not only by the 37 straight bet”.

When it is determined that there is no player who made the bet on the specific pocket 23 (step S102: NO), the processing moves to step S100. On the other hand, when it is determined that there is a player who made the bet on the specific pocket 23 (step S102: YES), it is determined whether or not there are two or more players who made the bet on the specific pocket 23 (step S103). When it is determined that there are not two or more players who made the bet on the specific pocket 23 (step S103: NO), the processing moves to step S105.

On the other hand, when it is determined that there are two or more players who made the bet on the specific pocket 23 (step S103: YES), one player is selected among the two or more players (step S104). Here, for example, the one player is selected based on the betting method. In other words, for example, priority is given in advance in order of “straight bet”, “split bet”, “street bet”, and “corner bet”, and one player with the highest priority is selected. Alternatively, one player who made the bet the largest number of medals may be selected. Or one player who gets the smallest payout amount up to now may be selected. Alternatively, one player may be selected based on the combination of the above-mentioned three selection methods. Incidentally, the selection method of one player is not limited to any one of the above-mentioned methods and another method may be employed for selection.

After the selection of one player, a screen image, which indicates that changing the control data is acceptable, is displayed at the station 4 for the one player (step S105). When there are not two or more players who made the bet on the specific pocket 23, the player who made the bet on the specific pocket 23 is selected. When the above screen image is displayed for the one player, it is possible for the one player to change the control data to another control data. To give a concrete example, on a screen display device 8 of the station 4, the top view of the roulette wheel 22 as shown in FIG. 2 and areas A to F (six divided areas of the plurality of the pockets 23) are displayed. The player who has obtained the right can change the current control data to another control data by selecting one of the six areas A to F. At this time, it is possible to change the current control data to another control data by making the current area unavailable to select. In this manner, it is possible for a specific player to play games advantageously and expect a high dividend by giving the right to change the control data to another control data to the player who has satisfied a predetermined condition (“step S101: YES” and “step S102: YES”, and further, when there are two or more players, the player is selected in step 104). Due to this, the gaming amusement is improved.

After changing the control data to another, the number of continuation times of the game by the other control data is determined (step S106). The number of games is determined randomly and even the player who has changed the control data cannot know the number. Due to this, the player who has changed the control data is obliged to determine how long the game continues by the other control data, and thereby, the gaming amusement is further improved.

After that, a screen image, which indicates that the control data has been changed, is displayed to other players (step S107). Due to this, for example, it is possible to notify friends that the area having higher probability of receiving the ball 27 has been changed if the friends are playing at different stations 4 of the same gaming machine 1. Consequently, it is possible for the friends to play the game advantageously along with the player. Due to this, the gaming amusement is further improved. By the way, it may also be possible to notify not only the fact that the area having higher probability of receiving the ball 27 has been changed but also that area itself.

Next, the detailed configuration of the roulette gaming machine 1 according to the present embodiment will be described. As shown in FIG. 2, a roulette apparatus 3 of the roulette gaming machine 1 includes a frame body 21 fixed on a cabinet 2 (refer to FIG. 3) and the roulette wheel 22 rotatably accommodated and supported inside the frame body 21. On the top surface of the roulette wheel 22, many number pockets 23 (38 pockets in total in the present embodiment) are formed. Further, on the top surface of the roulette wheel 22 outside each of the number pockets 23, there is provided a number plate 25 displaying each number of “0”, “00”, “1” to “36” corresponding to each number pocket 23.

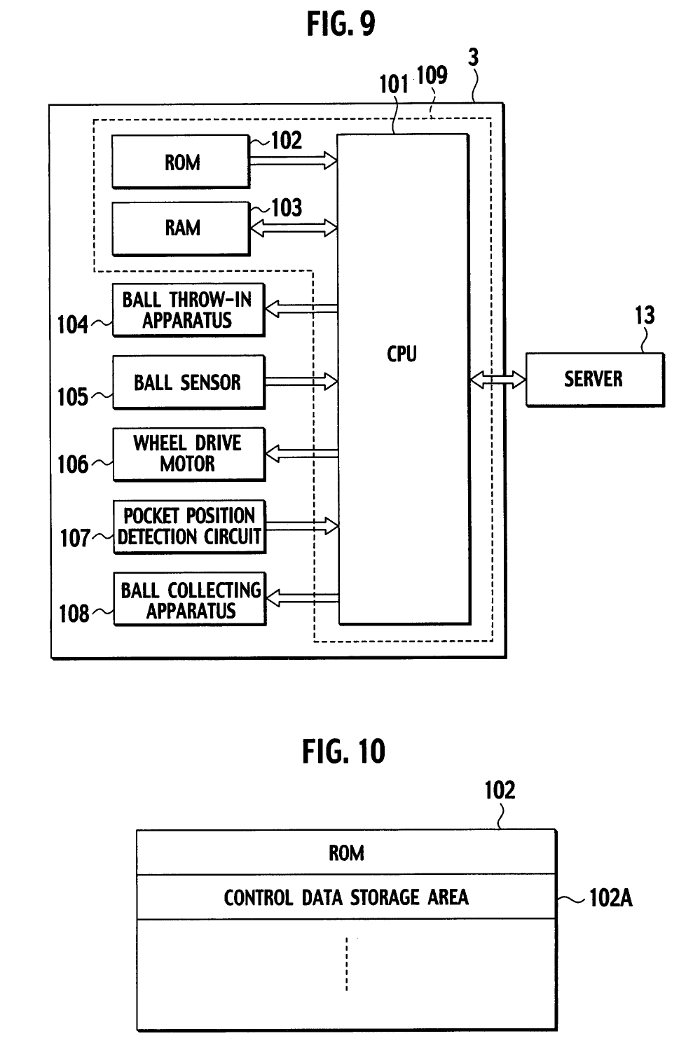

Within the frame body 21, a ball throw-in opening 36 is formed. To the ball throw-in opening 36, a ball throw-in apparatus 104 (refer to FIG. 9) is coupled. Accompanying the drive of the ball throw-in apparatus 104, the ball 27 is thrown onto the roulette wheel 22 from the ball throw-in opening 36. In addition, a hemisphere-shaped transparent acryl cover 28 (refer to FIG. 3) covers the whole of the roulette apparatus 3 thereabove.

Below the roulette wheel 22, a wheel drive motor 106 (refer to FIG. 9) is provided. Accompanying the drive of the wheel drive motor 106, the roulette wheel 22 rotates.

In addition, below the roulette wheel 22, metal plates (not shown) are attached at predetermined intervals. A proximity sensor of a pocket position detecting circuit 107 (refer to FIG. 9) detects the metal plate, and thereby, the position of the number pocket 23 is detected.

The frame body 21 is inclined gradually toward the inside and a guide wall 29 is formed in the middle thereof. The thrown-in ball 27 rotates by its centrifugal force, being guided by the guide wall 29. When the rotation speed decreases and the centrifugal force lessens, the ball 27 rolls down the slope of the frame body 21 inwardly, reaching the rotating roulette wheel 22. Then, the ball 27 that has reached the roulette wheel 22 passes through the top of the number plate 25 outside the rotating roulette wheel 22 and is received in any one of the number pockets 23. As a result, the number of the number pocket 23 that has received the ball 27 is detected by a ball sensor 105 (refer to FIG. 9). The detected number is a winning number.

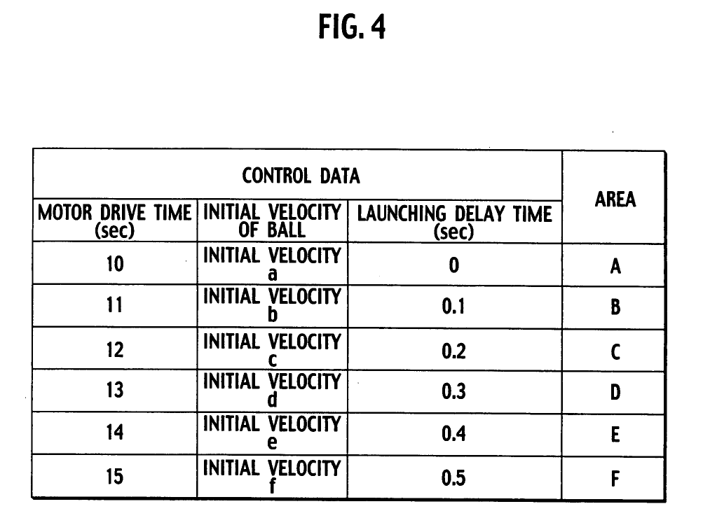

The rotation of the roulette wheel 22 and the launching of the ball 27 are executed based on the control data. FIG. 4 is a diagram showing an example of the control data. As shown in FIG. 4, the control data includes a motor drive time, a ball initial velocity, and a launching delay time.

The motor drive time is a time for which the wheel drive motor 106 (refer to FIG. 9) is driven. The roulette wheel 22 is rotated at a predetermined rotation speed for the motor drive time by the wheel drive motor 106. After the drive by the wheel drive motor 106 is ended, the rotation speed decreases gradually and then the roulette wheel 22 comes to a stop after a while. The ball initial velocity is an initial velocity at which the ball 27 is thrown in from the ball throw-in apparatus 104. The launching delay time is a time from when one of the number pockets 23, which is a predetermined one, passes by a predetermined position until the ball 27 is launched.

As shown in FIG. 2, the roulette wheel 22 is divided into six areas (specific portions) A to F. Each area consists of neighboring six or seven of the number pockets 23.

Each of the control data is set so that any one of the areas A to F would receive the ball 27 with higher probability. For example, when the rotation of the roulette wheel 22 and the launching of the ball 27 are controlled based on the control data of “the motor drive time is 10 sec, the ball initial velocity is a, and the launching delay time is 0”, the area A would receive the ball 27 with higher probability. By the way, the control data may be set individually for each of the roulette apparatuses 3 or may be set commonly to all of the roulette gaming machines 1.

In the above-described example, the case has been described, where each of the areas A to F consists of neighboring six or seven of the number pockets 23. However, the number of pockets 23 that belong to one group is not limited in particular. In addition, the number of pockets constituting each group may be the same to or may be different from one another. Further, in the present embodiment, the case has been described, where the number pockets 23 are divided into the six areas (groups) A to F. However, the number of pockets 23 included in one group is not limited to six.

In the above-described example, the case has been described, where the areas A to F do not overlap one another. In other words, the case has been described, where the pockets 23 that belong to one group and do not belong to another group. However, this is not limited, and one pocket may belong to two or more groups.

In the above-described example, the case has been described, where each control data is associated with each area (group) respectively. However, as far as two or more control data exist, there may be an area (group) with which no control data is associated or there may be an area (group) with which two or more control data are associated.

In the above-described example, the case has been described, where the control data is composed of the motor drive time, the ball initial velocity, and the launching delay time. However, the control data is not limited to this. The control data may include any one of the data relating to the rotation control of the wheel 22 (motor drive time), data relating to the launching timing of the ball 27 (launching delay time), and data relating to the launching initial velocity of the ball 27 (ball initial velocity), or data including a combination thereof. Further, for example, as the data relating to the rotation control of the wheel 22, the rotation speed of the roulette wheel 22 may be accepted in addition to the motor drive time.

Next, FIG. 3 is referred to. As shown in FIG. 3, the roulette gaming machine 1 comprises the cabinet 2 to be the main body, the roulette apparatus 3 provided substantially in the center on the top surface of the cabinet 2, a plurality of the stations 4 (12 units in the present embodiment) arranged so as to surround the roulette apparatus 3, and an electroluminescence display (large-sized display) 5 provided above the cabinet 2.

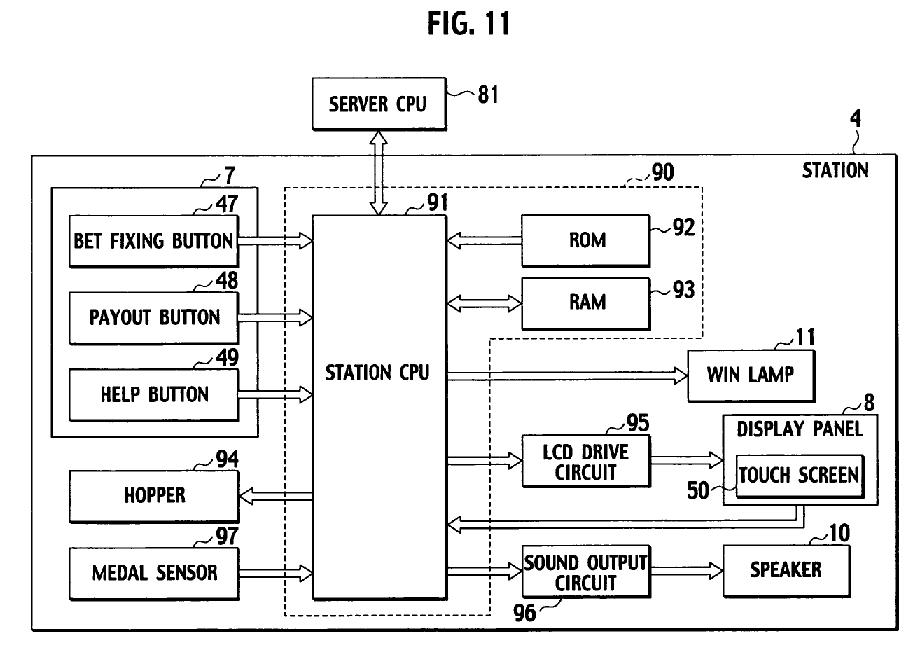

The station 4 is an apparatus that accepts a player's bet. The station 4 includes at least a medal insertion slot 6 through which a coin or a game medium (currency value: such as a chip, a medal, etc.) is inserted, a console 7 consisting of a plurality of control buttons with which a player inputs predetermined directions and a display panel 8 that displays an image relating to a game. It is possible for the player to advance a game by operating a touch screen 50 (refer to FIG. 11), the console 7 and so on while watching an image displayed on the display panel 8.

In addition, on the side of the cabinet 2 in which each station 4 is arranged, a medal payout opening 9 is provided respectively. Further, at the top-right of the display panel 8 of each station 4, a speaker 10 that outputs music, effect sounds is provided.

On the top of the display panel 8 of each station 4, WIN lamps 11 are provided respectively. The WIN lamp 11 at the station 4 that has won lights up when a number (“0”, “00”, “1” to “36” in the present embodiment), which was bet at the station 4 in a game, is won. Similarly, the WIN lamp 11 also lights up at the station 4 that has won the jackpot (hereinafter, referred also to JP) in a JP bonus game. The WIN lamps 11 can be recognized visually from all of the stations 4 (12 units in the present embodiment). It is possible for other players playing with the same roulette gaming machine 1 to check the lighting of the WIN lamp 11 at all times.

Within the medal insertion slot 6, a medal sensor 97 (refer to FIG. 11) is provided for identifying the currency value of the medal inserted through the medal insertion slot 6 as well as counting the inserted medals. In addition, within the medal payout opening 9, a hopper 94 (refer to FIG. 11) is provided for paying out a predetermined number of medals from the medal payout opening 9.

Within a corner 12 of the cabinet 2, a server 13 is installed. Normally, the server 13 is accommodated within the corner 12 so as to prevent operations by a player. It is possible for an administrator of the roulette gaming machine 1 to operate the server 13 by opening a door 14 on the corner 12 using a key switch. Then, by operating the server 13, it is possible to set various settings of the roulette gaming machine 1.

On the electroluminescence display 5, a JP amount display 15 for displaying the amount of JP is provided. In the roulette gaming machine 1 according to the present embodiment, three kinds of JP, that is, “MEGA”, “MAJOR”, and “MINI” are provided, as will be described later. The “MEGA” JP accumulates and stores 0.15% of credits bet at all of the 12 stations 4. The “MAJOR” JP accumulates and stores 0.20% of bet credits. The “MINI” JP accumulates and stores 0.30% of bet credits. Then, one of JPs is won in a JP bonus game, which will be described later, the credits corresponding to the accumulated amount of the relevant JP are paid out for the predetermined station 4. On the JP amount display 15, the accumulated amount of the “MEGA” JP is displayed among the three kinds of JP. The JP amount display 15 is provided on the top part of the electroluminescence display 5 and the display contents can be visually recognized by all of the players who play at the stations 4.

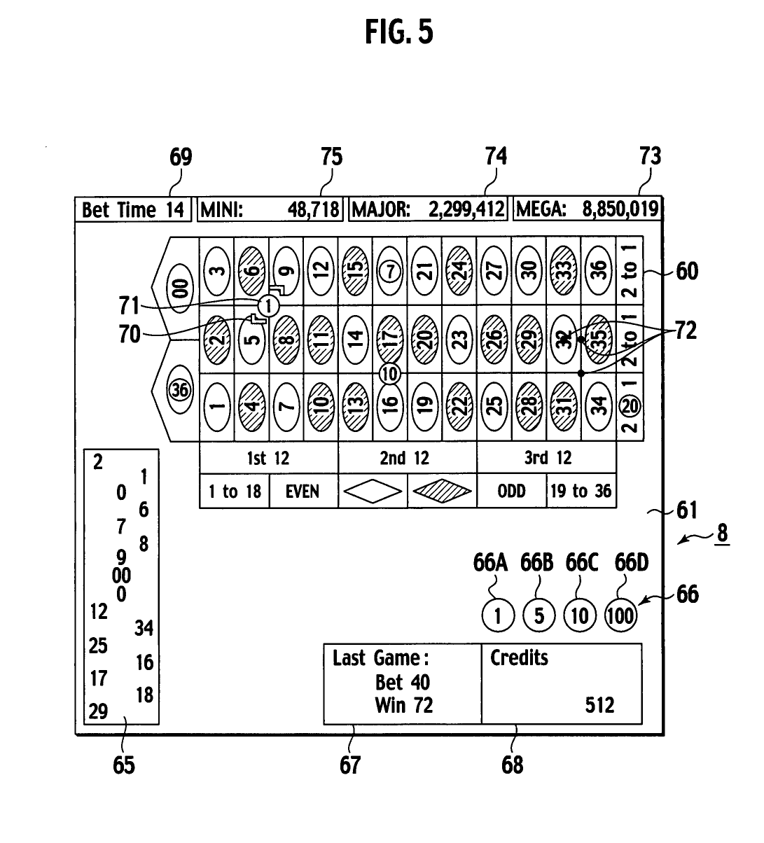

FIG. 5 is a diagram showing an example of an image displayed on the display panel 8. As shown in FIG. 5, during a game, a bet screen 61 having a betting board 60 is displayed on the display panel 8. The player can bet a chip using the own credits with the touch screen 50 provided on the front of the display panel 8.

First, based on FIG. 5, the bet screen 61 during a game will be described. On the betting board 60 displayed on the bet screen 61, 38 kinds of numbers, that is, “0”, “00”, “1” to “36”, are arranged and displayed in a matrix. In addition, specific bet areas are also arranged in a matrix for betting a chip by specifying “odd numbers”, “even numbers”, “the kind of color (red or black) of the number”, and “a certain range of numbers (for example, “1” to “12”, etc.)”.

Below the betting board 60, a result history display 65-bet buttons 66, a payout result display 67 and a number of credits display 68 are displayed. On the result history display 65, the result of the winning numbers in the games up to the last game are displayed in a list. By the way, one game is a series of operations from when each player bets at each of the stations 4, then the ball 27 falls in the number pocket 23 and until payout is made based on the winning number. On the result history display 65, when one game is over, the most recent winning number is added from the top and displayed, and thereby the history of the winning numbers up to 16 games can be confirmed.

In addition, the bet buttons 66 are buttons for betting a chip(s) on a bet area 72 (on the grid of a number or mark, or on the line forming the grid) specified by the player. The bet buttons 66 consist of four kinds of buttons, that is, a 1-bet button 66A, a 5-bet button 66B, a 10-bet button 66C, and a 100-bet button 66D.

The player specifies a bet position with a cursor 70 to be described later by directly touching the bet area 72 on which to bet on the screen with a finger etc. By touching the 1-bet button 66A once in this state, the player can bet one chip. Each time the 1-bet button 66A is touched with a finger etc., the number of bets increases in the order of “1”→“2”→“3”→ . . . . In addition, by touching the 5-bet button 66B once, five chips can be bet. Each time the 5-bet button 66B is touched with a finger etc., the number of bets increases in the order of “5”→“10”→“15”→ . . . .

By touching the 10-bet button 66C once, 10 chips can be bet. Each time the 10-bet button 66C is touched with a finger etc., the number of bets increases in the order of “10”→“20”→“30”→ . . . . Further, by touching the 100-bet button 66D once, 100 chips can be bet. Each time the 100-bet button 66D is touched with a finger etc., the number of bets increases in the order of “100”→“200”→“300”→ . . . .

The payout result display 67 displays the number of bets of the player and the number of credits to be paid out for that. Here, the number of credits to be paid out subtracted by the number of bets is the number of credits newly won by the player.

The number of credits display 68 displays the number of credits currently possessed by the player. The number of credits decreases in accordance with the number of bets (one credit for one bet). However, when credits are paid out when winning, the number of credits increases by that corresponding to the amount of payout. When the number of credits possessed by the player becomes zero, the game is closed.

On the top of the betting board 60, a bet time display 69 is provided. The bet time display 69 displays a remaining time available for betting by the player. When bet acceptance starts, “20” is displayed and the number decreases one by one for each second and when the number reaches “0”, the bet acceptance is closed. In addition, when the remaining time for the player to bet is five seconds at each of the stations 4, the ball throw-in apparatus 104 is driven and the ball 27 is thrown onto the roulette plate.

On the right side of the bet time display 69, a MEGA display 73 that displays the accumulated number of credits of the “MEGA” JP, a MAJOR display 74 that displays the accumulated number of credits of the “MAJOR” JP, and a MINI display 75 that displays the accumulated number of credits of the “MINI” JP are provided.

On the MEGA display 73, the cumulative sum of 0.15% of the credits bet in each game at all of the 12 stations 4 is displayed. On the MAJOR display 74, the cumulative sum of 0.20% of the bet credits is displayed. On the MINI display 75, the cumulative sum of 0.30% of the bet credits is displayed. The numerical values displayed on the MEGA display 73, the MAJOR display 74, and the MINI display 75 are common to all of the stations 4. In the case of winning in the JP bonus game, the number of credits of the JP that is won among the JPs displayed on each of the displays 73 to 75 is paid out. After payout is made, the initial values (200 credits for “MINI”, 5,000 credits for “MAJOR”, and 50,000 credits for “MEGA”) are displayed on the displays of the JP.

On the betting board 60, the cursor 70 indicative of the bet area 72 currently selected by the player is displayed. In addition, on the betting board 60, a chip mark 71 indicative of the number of chips already bet and the bet area 72 is displayed. The number displayed on the chip mark 71 indicates the number bet. For example, as shown in FIG. 5, the chip mark 71 of “7” placed on the grid “18” indicates that seven chips are bet on the number “18”. Incidentally, betting on only one number is called “straight bet”.

The chip mark 71 of “1” placed on the intersection point of the grids “5”, “6”, “8” and “9” indicates that one chip is bet on the four numbers “5”, “6”, “8” and “9”. Incidentally, such betting on four numbers is called “corner bet”.

Other betting methods include “split bet” for betting on two numbers by placing a chip on the line between the two numbers, “street bet” for betting on three numbers (for example, “13”, “14” and “15”) by placing a chip on the end of the horizontal line (a line in the longitudinal direction in FIG. 5) and “five bet” for betting on five numbers of “0”, “00”, “1”, “2” and “3” by placing a chip on the line between the numbers “00” and 3”.

Further, other betting methods include “line bet” for betting on six numbers (for example, “13”, “14”, “15”, “16”, “17” and “18”) by placing a chip between ends of two horizontal lines (two lines in the longitudinal direction in FIG. 5), “column bet” for betting on 12 numbers on the grid denoted by “2 to 1” and “dozen bet” for betting on successive 12 numbers by placing a chip on the grid denoted by “1st 12”, “2nd 12” or “3rd 12”.

Furthermore, there are other betting methods using six grids provided in the lowest tier of the betting board 60, such as a method for betting on the color of the number display plate (“red” or “black”), a method for betting on odd or even numbers and a method for betting on 18 numbers “1 to 18” or “19 to 36”. Here, these plural betting methods differ in the dividend of credits per chip (payout rate) when the game is won.

When betting on the bet screen 61 configured as described above, the player first specifies the bet area 72 (the grid of a number or mark, or the line forming the grid) on which to bet by directly touching the screen with a finger. As a result, the cursor 70 moves to the specified bet area 72.

After that, by touching each unit button of the bet buttons 66 (the 1-bet button 66A, the 5-bet button 66B, the 10-bet button 66C, and the 100-bet button 66D), chips for the number of units are bet on the specified bet area 72. For example, when the 10-bet button 66C is touched four times, the 5-bet button 66B is touched once and the 1-bet button 66A is touched three times, then 48 chips are bet.

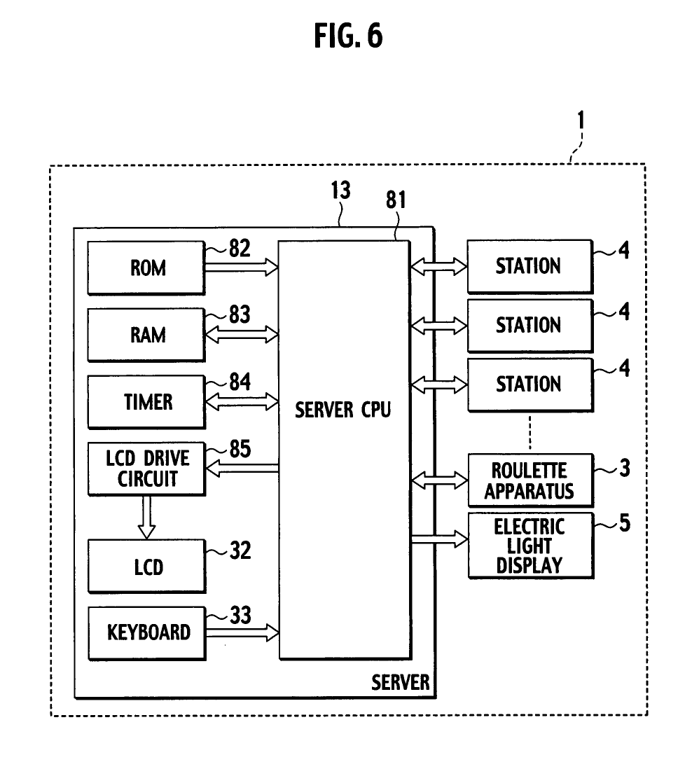

FIG. 6 is a block diagram showing the internal configuration of the roulette gaming machine according to the present embodiment. As shown in FIG. 6, the roulette gaming machine 1 includes the server 13, the plurality of the stations 4 (12 units in the present embodiment) connected to the server 13, the roulette apparatus 3 and the electroluminescence display 5 (refer to FIG. 3). By the way, the internal configuration of the roulette apparatus 3 and the internal configuration of the station 4 will be described in detail later.

The server 13 has a server CPU 81 that controls in whole, a ROM 82, a RAM 83, a timer 84, an LCD (Liquid Crystal Display) 32 connected via an LCD drive circuit 85 and a keyboard 33.

The server CPU 81 executes various kinds of processing based on input signals supplied from each of the stations 4 and data & programs stored in the ROM 82 & the RAM 83. In addition, by transmitting command signals to the stations 4 based on the processing result, the server CPU 81 controls each of the stations 4 initiatively. Further, the server CPU 81 transmits control signals to the roulette apparatus 3 and controls the launching of the ball 27 and the rotation of the roulette wheel 22.

The ROM 82 is constituted by, for example, a semiconductor memory, etc. The ROM 82 stores programs that implement basic functions of the roulette gaming machine 1, programs that execute the notification of the maintenance time and the setting & management of the notification condition, dividend rate data (the number of credits to be paid out for winning per chip) of the roulette game and programs that control each of the stations 4, etc.

The RAM 83 temporarily stores the bet information supplied from each of the stations 4, the winning number of the roulette apparatus 3 determined by the sensor, the accumulated amount of JP and data about the result of the processing executed by the server CUP 81, etc.

The timer 84 for time measurement is connected to the server CPU 81. The time information of the timer 84 is transmitted to the server CPU 81 and the server CPU 81 controls the rotation of the roulette wheel 22 and the thrown-in of the ball 27 to be described later based on the time information of the timer 84.

In addition, the server CPU 81 executes the effect by electric decoration by controlling the light emission of an LED of the electroluminescence display 5. Further, the server CUP 81 displays predetermined letters on the electroluminescence display 5. Furthermore, the server CPU 81 displays the accumulated amount of JP (the “MEGA” JP in the present embodiment) on the JP amount display 15 of the electroluminescence display 5.

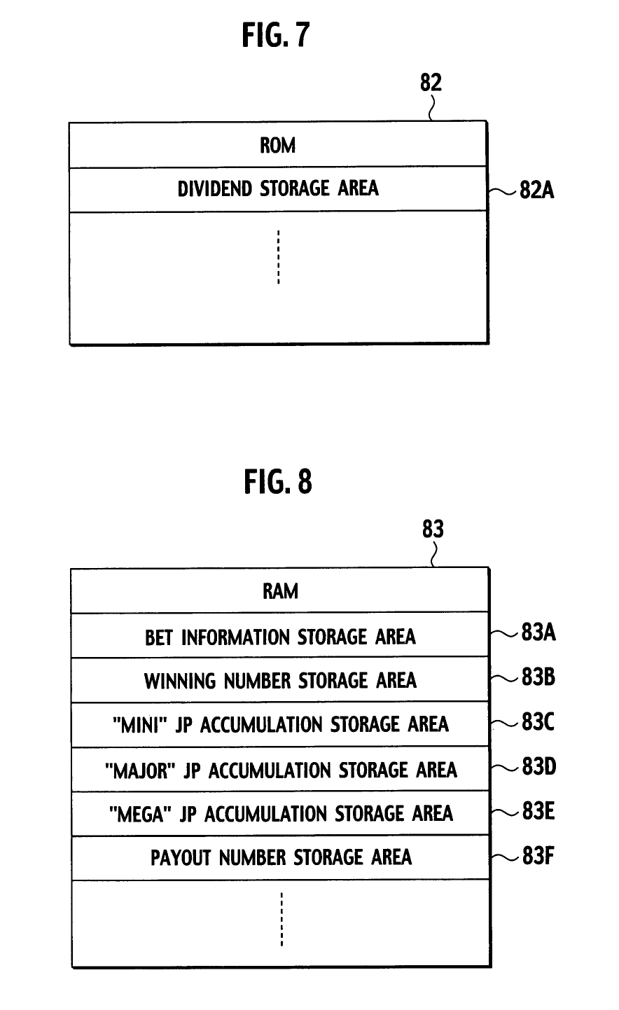

FIG. 7 is a schematic diagram showing the storage area of the ROM 82 of the roulette gaming machine 1 according to the present embodiment. As shown in FIG. 7, the ROM 82 has a dividend storage area 82A storing the dividend rate relating to the game. Incidentally, the dividend rate for each bet area 72 stored in the dividend storage area 82A is determined in advance as “×2” to “×36” depending on the kind of betting (“straight bet”, “corner bet”, “split bet”, etc.).

FIG. 8 is a schematic diagram showing the storage area of the RAM 83 of the roulette gaming machine 1 according to the present embodiment. As shown in FIG. 8, the RAM 83 has abet information storage area 83A storing the bet information of the player now playing the game, a winning number storage area 83B storing the winning number of the roulette apparatus 3 determined by the ball sensor 105, a “MINI” JP accumulation storage area 83C storing the number of accumulated credits of the “MINI” JP, a “MAJOR” JP accumulation storage area 83D storing the number of accumulated credits of the “MAJOR” JP and a “MEGA” JP accumulation storage area 83E storing the number of accumulated credits of the “MEGA” JP. Specifically, the bet information is information about the bet area 72 specified on the bet screen 61 (refer to FIG. 5), the number of bet chips (number of bets) and the betting at the station 4 such as the kind of betting etc.

FIG. 9 is a block diagram showing the internal configuration of the roulette apparatus 3 according to the present embodiment. As shown in FIG. 9, the roulette apparatus 3 includes a controller 109, the pocket position detecting circuit 107, the ball throw-in apparatus 104, the ball sensor 105, the wheel drive motor 106 and a ball collecting apparatus 108.

The controller 109 has a CPU 101, a ROM 102 and a RAM 103. The CPU 101 controls the launching of the ball 27 and the rotation of the roulette wheel 22 based on control signals supplied from the server 13 and data & programs stored in the ROM 102 & the RAM 103.

FIG. 10 is a schematic diagram showing the storage area of the ROM 102 of the roulette apparatus 3 according to the present embodiment. As shown in FIG. 10, the ROM 102 has a control data storage area 102A and stores the control data shown in FIG. 4.

FIG. 9 is referred to again. The pocket position detecting circuit 107 has a proximity sensor. The pocket position detecting circuit 107 detects the rotating position of the roulette wheel 22 by detecting the metal plates attached to the roulette wheel 22.

The ball throw-in apparatus 104 throws in the ball 27 onto the roulette wheel 22 from the ball throw-in opening 36 (refer to FIG. 1). The ball throw-in apparatus 104 throws in the ball 27 at the initial velocity set in the control data. In addition, the ball throw-in apparatus 104 throws in the ball 27 with timing based on the launching delay time set in the control data. In other words, the ball 27 is thrown in when the launching delay time elapses after the pocket position detecting circuit 107 detects that the predetermined number pocket 23 (for example, “00”) has passed by a predetermined position (for example, in front of the ball throw-in opening 36).

The ball sensor 105 detects which number pocket 23 has received the ball 27. The detection result is output as a detection signal. The wheel drive motor 106 rotates the roulette wheel 22. The wheel drive motor 106 stops driving when the motor drive time set in the control data elapses from the rotating start. The ball collecting apparatus 108 collects the ball 27 on the roulette wheel 22 after the game is over.

FIG. 11 is a block diagram showing the internal configuration of the station 4 according to the present embodiment. By the way, the stations 4 provided in 12 units have basically the same configuration and then one of the stations 14 will be described below as an example.

As shown in FIG. 11, the station 4 includes a station controller 90 constituted by a station CPU 91, a ROM 92 and a RAM 93. The ROM 92 is constituted, for example, by a semiconductor memory. The ROM 92 stores programs that implement basic functions of the station 4, various programs necessary for the control of the rest of the stations 4, data tables and so on. In addition, the RAM 93 temporarily stores various data operated by the station CPU 91, the number of credits possessed by the player (saved at the station 4), the state of betting by the player and so on.

In addition, a bet confirming button 47, a payout button 48 and a help button 49 provided on the console 7 (refer to FIG. 3) are connected to the station CPU 91 respectively.

The bet confirming button 47 is a button that confirms the bet after the betting operation on the display panel 8. The payout button 48 is pressed down normally when the game is over. When the payout button 48 is pressed down, medals in accordance with the credits possessed by the player (normally, one medal for one credit) are paid out from the medal payout opening 9. The help button 49 is pressed down when the operation method of the game is unclear. When the help button 49 is pressed down, a help screen showing various kinds of operation information is displayed on the display panel 8.

The station CPU 91 performs control to execute various corresponding operations based on the operation signal output when each button is pressed down. Specifically, the station CPU 91 executes various kinds of processing based on the input signal supplied from the console 7 by the player s operation and the data & programs stored in the ROM 92 & the RAM 93. And the station CPU 91 transmits the processing result to the server CPU 81.

In addition, the station CPU 91 receives the command signal from the server CPU 81 and advances the game by controlling the peripheral devices constituting the station 4. The station CPU 91 executes various kinds of processing in accordance with the contents of the processing based on the input signal supplied from the console 7 by the player's operation and the data & programs stored in the ROM 92 & the RAM 93. The station CPU 91 advances the game by controlling the peripheral devices constituting the station 4 based on the processing result.

Further, a hopper 94 is connected to the station CPU 91. The hopper 94 pays out a predetermined number of medals from the medal payout opening 9 (refer to FIG. 3) by the command signal from the station CPU 91.

Furthermore, the display panel 8 is connected to the station CPU 91 via an LCD drive circuit 95. The station CPU 91 causes the display panel 8 to display a reception screen of the control data change operation and an acceptance screen of the notification to other players via the LCD drive circuit 95. When the notification to other players by one of the players via the touch screen 50 is executed, the station CPU 91 transmits the signal of the notification to other players to the server 13. In the server 13, the server CPU 81 transmits the notification signal to the station 4 of the specified player. Due to this, the station CPU 91 of the station 4 of the specified player displays the notification screen on the display panel 8 via the LCD drive circuit 95.

The LCD drive circuit 95 includes a program ROM, an image ROM, an image control CPU, a work RAM, a VDP (Video Display Processor) and a video RAM.

The program ROM stores image control programs relating to the display on the display panel 8 and various kinds of selection tables. The image ROM stores, for example, dot data for forming an image displayed on the display panel 8. The image control CPU determines an image to be displayed on the display panel 8 among the dot data within the image ROM in accordance with the image control program within the program ROM based on the parameter set in the station CPU 91.

The work RAM is constituted as a temporary storage device when the image control program is executed by the image control CPU. The VDP forms a display image determined by the image control CPU and outputs to the display panel 8. Incidentally, the video RAM is constituted as a temporary storage device when an image is formed by the VDP.

In addition, to the front of the display panel 8, the touch screen 50 is attached as described above. The operation information on the touch screen 50 is transmitted to the station CPU 91. On the touch screen 50, the player's betting operation is performed. Specifically, the operation of the touch screen 50 (such as the selection of the bet area 72 and the operation of the bet buttons 66) is performed and its information is transmitted to the station CPU 91. Then, the bet information (the bet area specified on the bet screen 61 and the number of bet chips) of the current player is constantly stored in the RAM 93 based on the information. Further, the bet information is transmitted to the server CPU 81 and stored in the bet information storage area of the RAM 83.

Furthermore, a sound output circuit 96 and the speaker 10 are connected to the station CPU 91. The speaker 10 generates various kinds of effect sounds when executing various effects based on the output signal from the sound output circuit 96.

In addition, the medal sensor 97 is connected to the station CPU 91. The medal sensor 97 detects a medal inserted through the medal insertion slot 6 (refer to FIG. 3). At the same time, the medal sensor 97 counts the inserted medals and transmits the result to the station CPU 91. The station CPU 91 increases the number of credits of the player stored in the RAM 93 based on the transmitted signal.

In addition, the WIN lamps 11 are connected to the station CPU 91. The station CPU 91 lights up the WIN lamp 11 in a predetermined color when the betting on the bet screen 61 is won or when the JP is won.

In the configuration described above, the server CPU 81, the ROM 82, the RAM 83, the station CPU 91, the ROM 92, the RAM 93, the CPU 101, the ROM 102 and the RAM 103 function as a controller of the roulette gaming machine 1 according to the present embodiment.

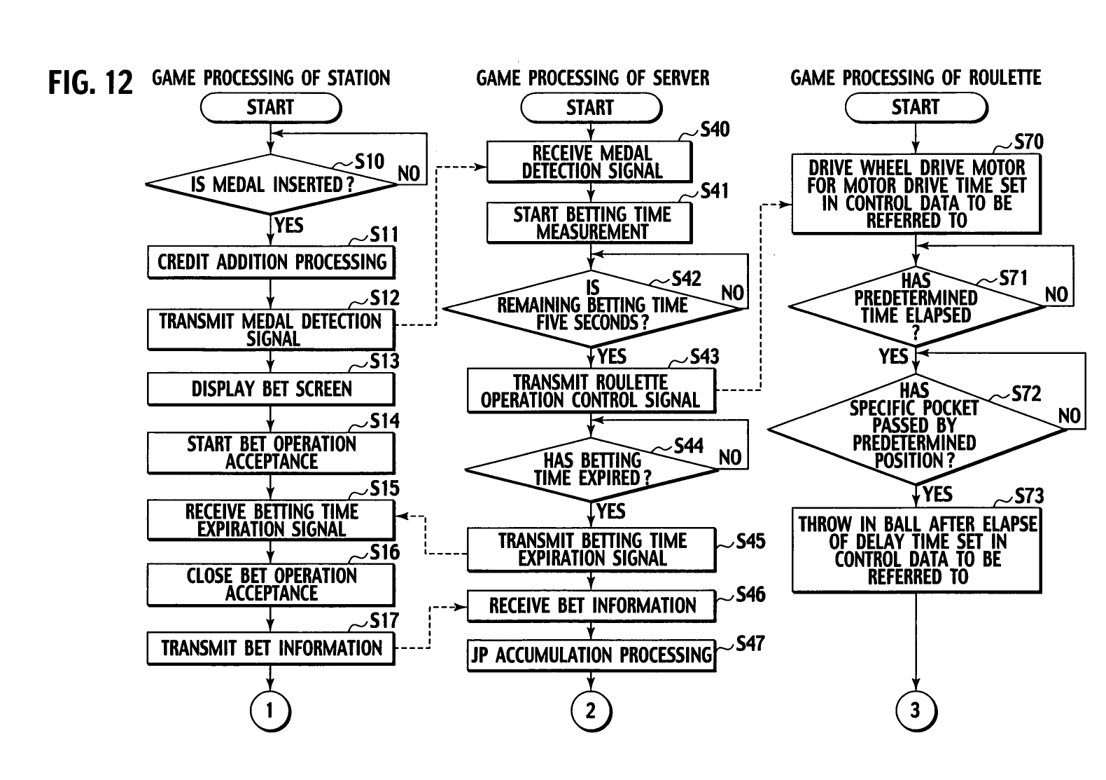

Next, the server game processing executed by the server CPU 81, the station game processing executed by the station CPU 91 and the game processing executed by the CPU 101 will be described based on FIGS. 12 to 15. FIGS. 12 to 15 are flowcharts showing the game processing of the roulette gaming machine according to the present embodiment.

First, the game processing of the station will be described based on FIGS. 12 to 15.

The station CPU 91 determines whether or not the player has inserted a medal or a coin based on the detection signal of the medal sensor 97 (step S10). When it is determined that a medal or coin has not been inserted (step S10: NO), this processing is repeated until it is determined that a medal or coin has been inserted.

On the other hand, when it is determined that a medal or coin has been inserted (step S10: YES), the station CPU 91 adds credits in accordance with the number of inserted medals or coins (step S11). In this processing, the station CPU 91 stores credit data in accordance with the number of inserted medals or coins in the RAM 93. Next, the station CPU 91 transmits the medal detection signal indicating that a medal or coin has been inserted to the server 13 (step S12).

After that, the station CPU 91 causes the display panel 8 of the station 4 to display the bet screen 61 shown in FIG. 4 (step S13). Next, the station CPU 91 starts measurement of the betting time available for betting (step S14). The player can bet on the bet area 72 predicted by the player by operating the touch screen 50 during the betting time (refer to FIG. 4). The player can also participate in the game after the betting time has already been started. With the roulette gaming machine 1 according to the present embodiment, up to 12 players can play the game. Further, the acceptance of the betting operation starts immediately after the previous game is over when the next is started continuously just after the previous game.

Next, the station CPU 91 receives a betting time expiration signal, which indicates the expiration of the betting time, from the server CPU 81 (step S15). Due to this, the station CPU 91 displays an image showing the expiration of the betting time on the display panel 8 and terminates the acceptance of the betting operation on the touch screen 50 (step S16).

After that, the station CPU 91 transmits the player's betting information (the specified bet area 72, the number of bets, the betting method) to the server 13 (step S17).

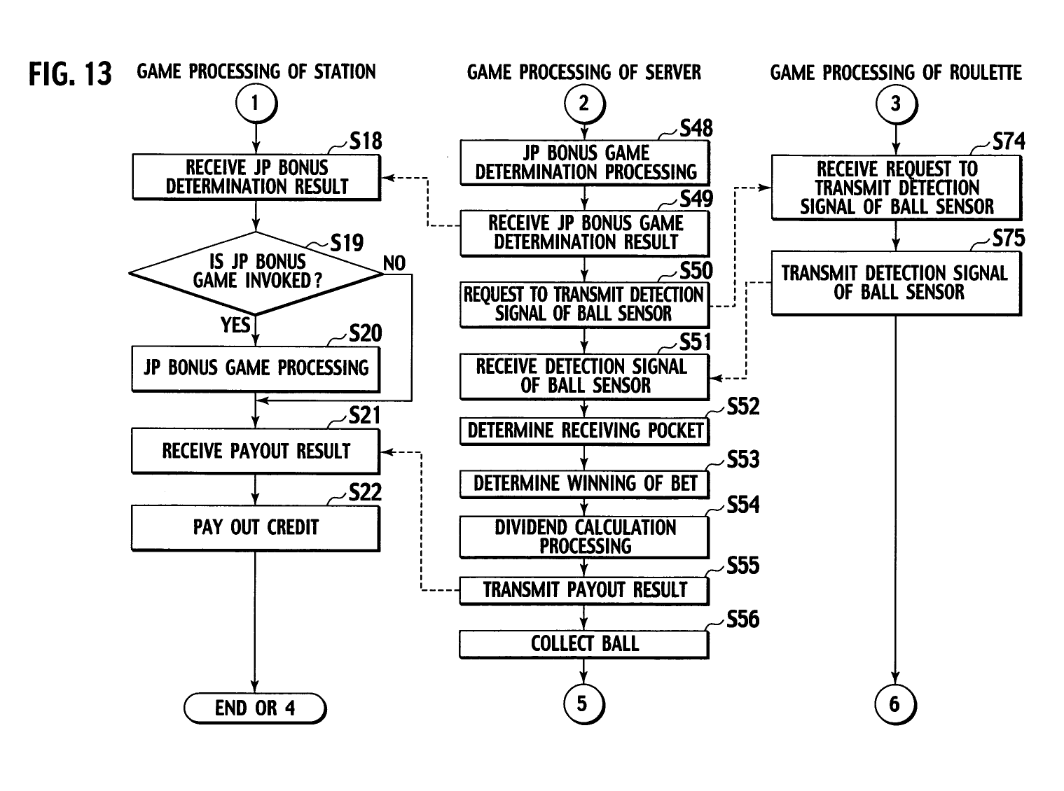

Next, the station CPU 91 receives the result of the determination processing of the JP bonus game from the server 13 (FIG. 13: step S18). The JP bonus game is executed by the server CPU 18 and will be described later. The determination result of the JP bonus game includes whether or not the predetermined JP bonus game is to be executed at each of the stations 4. Further, the determination result includes which one of the stations 4 is to win the JP (or all of the stations 4 are to lose) when the JP bonus game is executed. Furthermore, the determination result includes which one of the JPs (“MEGA”, “MAJOR” or “MINI”) is to be won when the JP is won.

After that, the station CPU 91 determines whether or not to execute the JP bonus game based on the result of the JP bonus game determination processing received in step S18 (step S19). When it is determined that the JP bonus game is not executed (step S19: NO), the processing moves to step S21.

On the other hand, when it is determined that the JP bonus game is executed (step S19: YES), the predetermined selection-type JP bonus game is executed and the result (whether or not the JP is hit) is displayed on the display panel 8 based on the determination result received in step S18 (step S20). After that, the processing moves to step S21.

In step S21, the station CPU 91 receives the payout result of credit from the server CPU 81 (step S21). Incidentally, the payout result of credit consists of the payout result of the base game and the JP payout result of the JP bonus game.

Next, the station CPU 91 makes payout of credit based on the payout result received in step S21 (step S22). Specifically, the credit data corresponding to the game dividend and the credit data corresponding to the accumulated JP dividend with the winning of the JP bonus game are stored in the RAM 93, respectively. Then, medals in accordance with the number of credits (normally, one medal for one credit) stored in the RAM 93 are paid out from the medal payout opening 9 when the payout button 48 is pressed down.

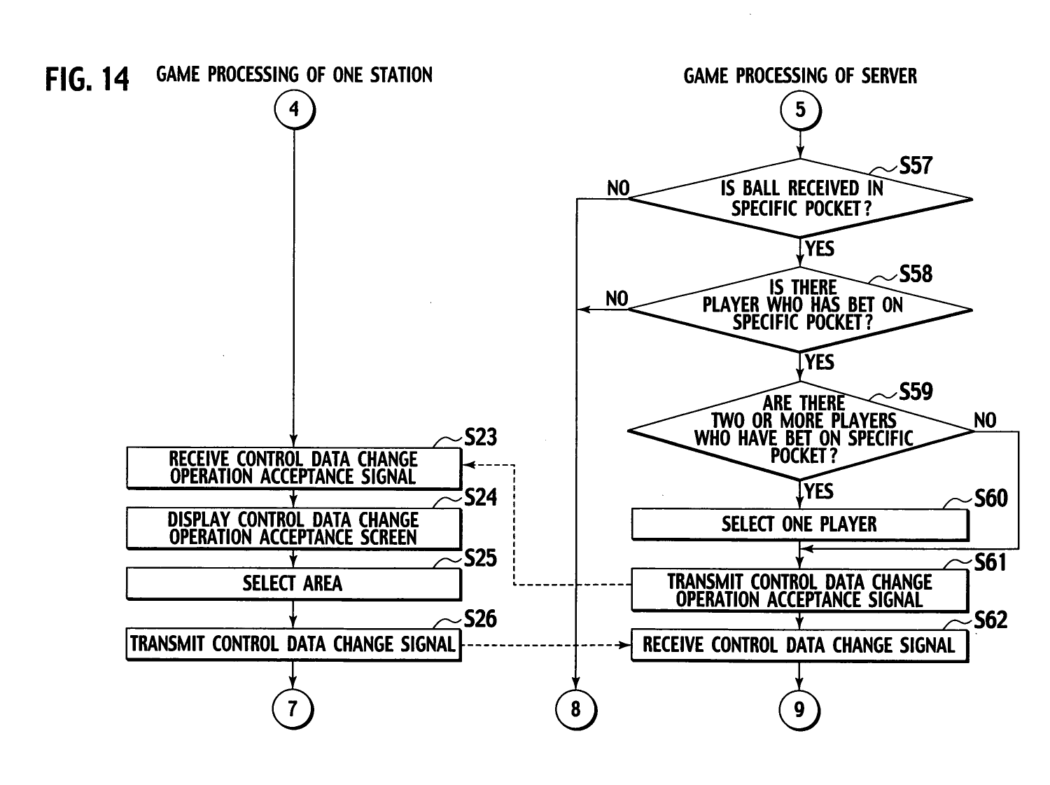

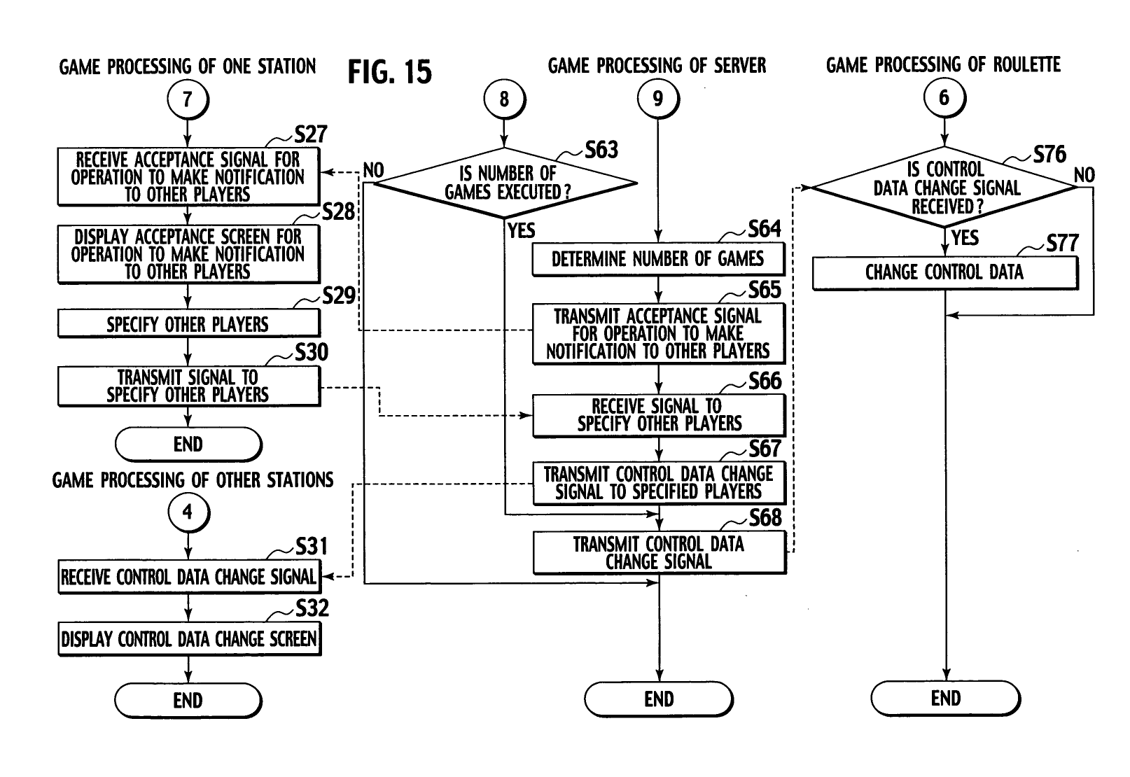

Next, FIG. 14 and FIG. 15 are referred to. Here, the processing at the station 4 of the player who made the bet on the specific pocket 23 having received the ball 27 (only one selected player if two or more players made the bet on the specific pocket 23) and the processing at the station 4 of another player who can receive the change notification of the control data from the player will be described separately. When the ball 27 is not received in the specific pocket 23 or when there is no player who made the bet on the specific pocket 23 having received the ball 27, the processing moves to step S13 after step S22. In this case, the betting time is started again and the next game is started. When the player terminates the game after executing payout, the processing moves to step S10.

First, the processing at the station 4 of the player (or one player selected when there are two or more players) who made the bet on the specific pocket 23 having received the ball 27 will be described.

As shown in FIG. 14, the station CPU 91 receives the signal to accept the control data change operation (step S23). Upon receipt of the signal, the station CPU 91 displays the acceptance screen of the control data change operation on the display panel 8 (step S24). As described above, the top view of the roulette wheel 22 shown in FIG. 2 and the six divided areas A to F of the plurality of the pockets 23 are displayed. Then, the player can operate to change the control data of one of the six areas A to F by the touch screen 50.

Next, the player selects one of the areas A to F (step S25). Due to this, the player can be informed of the area having higher probability of receiving the ball 27 at the subsequent game and expect a high dividend. After that, the station CPU 91 transmits the control data change signal to the server 13 (step S26).

The station CPU 91 receives the signal to accept the notification to other players from the server 13 (FIG. 15: step S27). Upon receipt of the signal, the station CPU 91 displays the acceptance screen of the notification on each display panel 8 of other players (step S28). Here, for example, the station numbers of all of the stations 4 are displayed and the player can operate to specify other players who can be informed that the control data has been changed by selecting the station number on the touch screen 50.

Next, the player specifies a station number (step S29) After that, the station CPU 91 transmits the signal to specify other players to the server 13 (step S30). Then, the processing moves to step S13 when the player continues the game. Alternatively, the processing moves to step 10 when the player terminates the game after executing payout.

Next, the processing of the station(s) 4 that has received the change notification of the control data will be described. As shown in FIG. 15, the station CPU 91 receives the control data change signal from the server 13 (step S31). Upon receipt of the signal, the station CPU 91 displays notice to the effect that the control data has been changed on the display panel 8 (step S32). Due to this, other players can know that the control data has been changed and expect a high dividend by changing the betting method at the subsequent game. Then, the processing moves to step S13 when the player continues the game. Alternatively, the processing moves to step S10 when the player terminates the game after executing payout.

In the above, the game processing itself is terminated when the game is terminated at all of the station 4.

Next, the game processing of the server will be described based on FIGS. 12 to 15.

First, the server CPU 81 receives the medal detection signal from the station CPU 91 and determines whether or not the player has inserted a medal or coin (step S40). In the roulette gaming machine 1 according to the present embodiment, the medal detection signal is sent from the station CPU 91 of the station 4 to the server CPU 81 when a medal or coin is inserted at any one of the stations 4.

Next, the server CPU 81 starts measurement of the betting time from the time point when the first player inserts a medal or coin and participates in the game (step S41). The betting time is a period during which the input of betting is possible. The player who has participated in the game can bet on the bet area 72 predicted by the player during the betting time by operating the touch screen 50.

Next, the server CPU 81 determines whether or not the remaining betting time is five seconds (step S42). Incidentally, the remaining betting time is displayed on the bet time display 69 (refer to FIG. 4). When it is determined that the remaining time is more than five seconds (step S42: NO), this processing is repeated.

On the other hand, when it is determined that the remaining time is five seconds (step S42: YES), the server CPU 81 transmits the control signal to start the operation of the roulette apparatus 3 to the CPU 101 (step S43).

After that, the server CPU 81 determines whether or not the betting time has expired (step S44). When it is determined that the betting time has not expired yet (step S44: NO), this processing is repeated. On the other hand, when it is determined that the betting time has expired (step S44: YES), the server CPU 81 transmits the betting time expiration signal to the station CPU 91 (step S45). Upon receipt of the expiration signal, the station CPU 91 terminates the acceptance of the betting operation at the station 4.

Next, the server CPU 81 receives the bet information (the specified bet area 72, the number of bets, the betting method) at the stations 4 from the each station CPU 91 (step S46) and stores the information in the bet information storage area 83A of the RAM 83.

After that, the server CPU 81 executes the JP accumulation processing based on the total credit bet at the stations 4 received in step S46 (step S47). In this processing, the server CPU 81 adds 0.30% of the total credit to the amount recorded in the “MINI” JP accumulation storage area 83C of the RAM 83. In addition, the server CPU 81 adds 0.20% of the total credit to the amount recorded in the “MAJOR” JP accumulation storage area 83D of the RAM 83 and adds 0.15% of the total credit to the amount recorded in the “MEGA” JP accumulation storage area 83E of the RAM 83. Further, the server CPU 81 updates the displays of the JP amount display 15, the MEGA display 73, the MAJOR display 74, and the MINI display 75 based on the JP amount.

Next, the server CPU 81 executes the JP bonus game determination processing (FIG. 13: step S48). In this processing, the server CPU 81 determines whether or not the JP bonus game is executed at each of the stations 4 using the random number value sampled in the sampling circuit, etc. Further, when it is determined that the JP bonus game will be executed, the server CPU 81 determines which one of the stations 4 will be win the JP (or all of the stations 4 are to lose). In addition, the server CUP 81 determines which one of the JPs (“MEGA”, “MAJOR”, or “MINI”) will be won.

Next, the server CPU 81 transmits the determination result of the JP bonus game to each of the stations 4 based on the processing in step S48 (step S49). After that, the server CPU 81 transmits the signal to request the detection signal of the ball sensor 105 to the roulette apparatus 3 (step S50). Due to this, the roulette apparatus 3 transmits the detection signal obtained by the ball sensor 105 to the server CPU 81. The server CPU 81 receives the detection signal (step S51).

Then, the server CPU 81 determines which number pocket 23 has received the ball 27 (step S52). Next, the server CPU 81 determines whether or not the betting at each of the stations 4 is winning based on the bet information of each of the stations 4 received in step S46 and the pocket determined in step S52 (step S53).

After that, the server CPU 81 executes the dividend calculation processing (step S54). In the dividend calculation processing, the server CPU 81 first recognizes the number of winning bets for each of the stations 4. Then, the server CPU 81 calculates the total amount of dividend of credit to be paid out using the dividend rate (the number of credits to be paid out per bet) stored in the dividend storage area 82A of the ROM 82.

Next, the server CPU 81 executes the transmission processing of the credit payout result based on the dividend calculation processing in step S54 (step S55). The server CPU 81 also executes the transmission processing of the JP payout results based on the JP bonus game determination processing in step S48 (step S55). Specifically, the server CPU 81 outputs credit data corresponding to the dividend amount to the station CPU 91 of the winning station 4. In addition, the server CPU 81 further outputs credit data corresponding to the accumulated JP amount to the station CPU 91 of the station 4 that has won the JP.

Then, the server CPU 81 transmits the control signal to the roulette apparatus 3 in order to drive the ball collecting apparatus 108 provided below the roulette wheel 22. Then the ball collecting apparatus 108 collects the ball 27 on the roulette wheel 22 (step S56). The collected ball 27 is thrown in onto the roulette wheel 22 again in the subsequent game.

Next, the server CPU 81 determines whether or not the ball 27 has been received in the specific pocket 23 (FIG. 14: step S57). When it is determined that the ball has been received in the specific pocket 23 (step S57: YES), the server CPU 81 determines whether or not there is a player who made the bet on the specific pocket 23 (step S58).

When it is determined that there is a player who made the bet on the specific pocket 23 (step S58: YES), the server CPU 81 determines whether or not there are two or more players who made the bet on the specific pocket 23 (step S59). When there is only one player who made the bet on the specific pocket 23 (step S59: NO), the processing moves to step S61.

On the other hand, when there are two or more players who made the bet on the specific pocket 23 (step S59: YES), the server CPU 81 selects one player among the two or more players (step S60). Here, as mentioned above, the server CPU 81 selects one player based on, for example, the betting method, the number of bets, the amount of payout up to now, etc.

After selecting one player, the server CPU 81 transmits the signal to accept the change operation of the control data to the selected player's station 4 (step S61). Due to this, the change operation acceptance screen of the control data is displayed at the selected player's station 4. Then, the player can play the game advantageously by changing the control data and expect a high dividend.

After that, the server CPU 81 receives the signal to change the control data from the station 4 of the player (step S62). After that, the server CPU 81 determines the number of continuation times of the game by the changed control data randomly (FIG. 15: step S64). Due to this random determination, the player is obliged to consider how many times the game with the changed control data continues and therefore the gaming amusement is further improved.

After that, the server control CPU 81 transmits the signal to accept the notification to other players to the selected player's station 4 (step S65). Then, the server control CPU 81 receives the signal to specify the player specified by the player (step S66).

After that, the server CPU 81 transmits the signal for changing the control data to the specified player's station 4 (step S67). After that, the server CPU 81 transmits the signal to the roulette apparatus 3 (step S68). At this time, the server CPU 81 transmits the signal for changing the higher-probability area from the current area to the player-selected area. Then, the processing moves to step S40.

By the way, when it is determined that the ball 27 has not been received in the specific pocket 23 (FIG. 14: step S57: NO), or it is determined that there is no player who made the bet on the specific pocket 23 (FIG. 14: step S58: NO), the processing moves to step S63 in FIG. 15. In step S63, the server CPU 81 determines whether or not the number of games determined in step S64 has been executed (step S63).

When it is determined that the number of games determined in step S64 has not been executed yet (step S63: NO), the processing moves to step S40. On the other hand, when it is determined that the number of games determined in step S64 has been executed (step S63: YES), the server CPU 81 transmits the control data change signal to the roulette apparatus 3 (step S68). At this time, the server CPU 81 transmits the signal to change the control data randomly. Then, the processing moves to step S40.

Next, the game processing of the roulette will be described based on FIG. 12, FIG. 13, and FIG. 15.

First, upon receipt of the operation signal of the roulette apparatus 3 from the server 13, the CPU 101 drives the wheel drive motor 106 for the motor drive time set in the current control data to rotate the roulette wheel 22 (step S70).

Next, the CPU 101 determines whether or not a predetermined time (for example, 20 seconds) has elapsed after the rotation of the roulette wheel 22 is started (step S71). When it is determined that the predetermined time has not elapsed (step S71: NO), this processing is repeated.

On the other hand, when it is determined that the predetermined time has elapsed (step S71: YES), the CPU 101 determines whether or not the specific pocket 23 (for example, “00”) has passed by a specific position (for example, in front of the ball throw-in opening 36) by the pocket position detecting circuit 107 (step S72). When it is determined that the specific pocket 23 has not passed by the specific position yet (step S72: NO), this processing is repeated.

On the other hand, when it is determined that the specific pocket 23 has passed by the specific position (step S72: YES), the CPU 101 drives the ball throw-in apparatus 104 to throw in the ball 27 after the delay time set in the current control data has elapsed (step S73). At this time, the ball throw-in apparatus 104 throws in the ball 27 at the initial velocity set in the control data.

After that, the CPU 101 receives the request signal described in step S50 from the server 13 (FIG. 13: step S74). Due to this, the CPU 101 transmits the detection signal of the ball sensor 105 to the server 13 (step S75).

Next, the CPU 101 determines whether or not the control data change signal has been received (FIG. 15: step S76). When it is determined that the control data change signal has not been received (step S76: NO), the processing moves to step S70.

On the other hand, when it is determined that the control data change signal has been received (step S76: YES), the CPU 101 changes the control data (step S77). Here, the CPU 101 changes the control data to one of the control data by which the player-selected area would receive the ball 27 with higher probability. Due to this, the motor drive time in step S70, the delay time in step S73, the initial velocity in step S63 and so on are changed. Then the specific pocket, which would receive the ball 27 with higher probability, is changed. After that, the processing moves to step S70. By the way, when the determination result is “YES” in step S63 and the control data is changed, the CPU 101 changes the control data randomly.

As described above, according to the roulette gaming machine 1 and the control method thereof according to the present embodiment, the pocket(s) 23 having higher probability of receiving the ball 27 is determined by the control data and during the progress of the game by one control data, when a player satisfies the predetermined condition, the change operation to another control data by the player is accepted.

In this manner, the right to change the one control data to the other control data is given to a player who satisfies the predetermined condition (for example, “steps S101, S102: YES” and when there are two or more players, one player is selected in step S104). Due to this, the specific player can advance the game advantageously and expect a high dividend, and in addition, the gaming amusement is improved.

In addition, the pocket(s) 23 having higher probability of receiving the ball 27 is determined by the control data and during the progress of the game by the one control data, when the ball 27 is received in the specific pocket 23 (for example, steps S101, S57: YES), if a certain player has bet on the specific pocket 23 (for example, steps S102, S58: YES), the change operation to the other control data by the player is accepted.

Due to this, it follows that the player is obliged to consider with enthusiasm whether or not to bet on the specific pocket 23 in order to obtain the right to change control data. Consequently, it is possible to further improve the gaming amusement.

In addition, the pocket(s) 23 having higher probability of receiving the ball 27 is determined by the control data and during the advancement of the game by the one control data, when the ball 27 is received in the specific pocket 23 (for example, steps S101, S57: YES), if one player has bet on the specific pocket 23 (for example, steps S102, S58: YES), the change operation to the other control data by the player is accepted. At this time, when there are two or more players who have bet on the specific pocket 23 (for example, steps S103, S59: YES), one player is selected among the two or more players and the change operation by the one player is accepted.

In this manner, when there are two or more players who have bet on the specific pocket 23, only one player is selected. Therefore, it is prevented that the right to change control data is given to two or more players and then the game is confused.

Further, after the change operation to the other control data is accepted, the number of times of the game by the other control data is determined randomly. Therefore even the player who has changed the control data cannot know the number of times of the game by the changed control data. As a result, it follows that the player is obliged to consider with enthusiasm the number of times of continuation and the gaming amusement is further improved.

Furthermore, after the change operation to the other control data is accepted, the notification operation by the player is accepted. Due to this, when friends played at different stations 4 of the same gaming machine 1, it is possible to notify the friends that the area having higher probability of receiving the ball 27 is changed. Therefore, it is possible to advance the game advantageously along with the friends. Due to this, it is possible to further improve the gaming amusement.

As describe above, the embodiments of the present invention have been described, however, they are just specific examples, not limiting the present invention in particular. The specific configuration of each unit etc. can be changed in design adequately. In addition, the effects described in the embodiments of the present invention are just enumerated as the most preferable effects that come from the present invention. The effects of the present invention are not limited to those described in the embodiments of the present invention.

In addition, in the detailed description above, the characteristic parts are focused on in the description for the purpose of easier understanding of the present invention. The present invention is not limited to the embodiments described in the detailed description above and can also be applied to other embodiments and the application range thereof is various. The terms and wording used in the present specification are used in order to describe the present invention accurately and are not limiting the interpretation of the present invention. It seems apparent that those skilled in the art can easily envisage other configurations, systems, methods, etc., included in the concept of the present invention from the concept of the present invention described in the present specification. Consequently, it should be understood that the description in the scope of the claims includes equivalent configurations in the range not deviating from the scope of the technical thought of the present invention.

In addition, each step to derive one result should be interpreted as processing without self-contradiction. Further, the processing in each step may be described by the expression common to the action of human beings, however, the processing described in the present specification should be executed in principle by various kinds of devices. Furthermore, other configurations required to execute each step will be made clear from the above description.

What is claimed is:

1. A gaming apparatus comprising:
a roulette wheel having a plurality of pockets numbered respectively;
a memory that stores a plurality of control data, in each of which at least one of a roulette wheel rotation condition and a ball launching condition is set so that probability of receiving a ball in a specific area of the plurality of pockets increases; and
a controller operable to accept, during a game executed based on one control data among the plurality of control data, a change operation from the one control data to another control data by a player who has satisfied a predetermined condition.

2. The gaming apparatus according to claim 1,
wherein the controller is operable to determine randomly the number of times of the game executed based on the other control data after accepting the change operation.

3. The gaming apparatus according to claim 1,
wherein the controller is operable to accept a notification operation to notify another player that the control data is changed by the player who has done the change operation after accepting the change operation.

4. A gaming apparatus comprising:
a roulette wheel having a plurality of pockets numbered respectively;
a memory that stores a plurality of control data, in each of which at least one of a roulette wheel rotation condition and a ball launching condition is set so that probability of receiving a ball in a specific area of the plurality of pockets increases; and
a controller operable to accept, during a game executed based on one control data among the plurality of control data, a change operation from the one control data to another control data by a player who has bet on the pocket included the specific area based on the one control data after the ball is received in the specific area.

5. The gaming apparatus according to claim 4,
wherein the controller is operable to determine randomly the number of times of the game executed based on the other control data after accepting the change operation.

6. The gaming apparatus according to claim 1,
wherein the controller is operable to accept a notification operation to notify another player that the control data is changed by the player who has done the change operation after accepting the change operation.

7. A gaming apparatus comprising:
a roulette wheel having a plurality of pockets numbered respectively;
a memory that stores a plurality of control data in each of which at least one of a roulette wheel rotation condition and a ball launching condition is set so that probability of receiving a ball in a specific area of the plurality of the pockets increases; and
a controller operable to:
(a) select, during a game executed based on one control data among the plurality of control data, one player among two or more players who have bet on the pocket included the specific area based on the one control data, and
(b) accept a change operation from the one control data to another control data by the one player after the ball is received in the specific area.

8. The gaming apparatus according to claim 7,
wherein the controller is operable to determine randomly the number of times of the game executed based on the other control data after accepting the change operation.

9. The gaming apparatus according to claim 7,
wherein the controller is operable to accept a notification operation to notify another player that the control data is changed by the player who has done the change operation after accepting the change operation.

10. A control method of a gaming apparatus, comprising:
accepting, during a game executed based on one control data among a plurality of control data in each of which at least one of a roulette wheel rotation condition and a ball launching condition is set so that probability of receiving a ball in a specific area of the plurality of pockets numbered respectively on a roulette wheel increases, a change operation from the one control data to another control data by a player who has satisfied a predetermined condition.

11. The control method of a gaming apparatus according to claim 10, further comprising:
determining randomly the number of times of the game executed based on the other control data after accepting the change operation.

12. The control method of a gaming apparatus according to claim 10, further comprising:
accepting a notification operation to notify another player that the control data is changed by the player who has done the change operation after accepting the change operation.

13. A control method of a gaming apparatus, comprising:
accepting, during a game executed based on one control data among a plurality of control data in each of which at least one of a roulette wheel rotation condition and a ball launching condition is set so that probability of receiving a ball in a specific area of the plurality of pockets numbered respectively on a roulette wheel increases, a change operation from the one control data to another control data by a player who has bet on the pocket included the specific area based on the on control data after the ball is received in the specific area.

14. The control method of a gaming apparatus according to claim 13, further comprising:
determining randomly the number of times of the game executed based on the other control data after accepting the change operation.

15. The control method of a gaming apparatus according to claim 13, further comprising:
accepting a notification operation to notify another player that the control data is changed by the player who has done the change operation after accepting the change operation.

16. A control method of a gaming apparatus, comprising:
selecting, during a game executed based on one control data among a plurality of control data in each of which at least one of a roulette wheel rotation condition and a ball launching condition is set so that probability of receiving a ball in a specific area of the plurality of pockets numbered respectively on a roulette wheel increases, one player among two or more players who have bet on the pocket included the specific area based on the one control data; and
accepting a change operation from the one control data to another control data by the one player after a ball is received in the specific area.

17. The control method of a gaming apparatus according to claim 16, further comprising:
determining randomly the number of times of the game executed based on the other control data after accepting the change operation.

18. The control method of a gaming apparatus according to claim 16, further comprising:
accepting a notification operation to notify another player that the control data is changed by the player who has done the change operation after accepting the change operation.
